(19) United States
(12) Patent Application Publication
(10) Pub. No.: US 2003/0231166 A1
(43) Pub. Date: Dec. 18, 2003

(54) Portable display system

(76) Inventor: Daniel Langlois, Montreal (CA)

Correspondence Address: BROUILLETTE KOSIE PRINCE, 25th Floor, 1100 Rene-Levesque Boulevard West, Montreal, QC, H3B 5C9, CA

(21) Appl. No.: 10/389,614

(22) Filed: Mar. 17, 2003

(30) Foreign Application Priority Data
Mar. 15, 2002 (CA) 2,376,896

(51) Int. Cl. G09G 5/00

(52) U.S. Cl. 345/169

(57) ABSTRACT

The invention relates to portable dynamic display device, which may be used with for instance advertising using multimedia presentations. The device of the invention may be configured to be mounted on a human body and carried from place to place while displaying a video image and playing an audio track.

The present invention relates to a portable dynamic display device. The device of the invention can be used, for example, as an advertising device using audiovisual presentations of digital image files, digital video files, and/or digital audio files.

Various methods for advertising exist today in abundance. Many of the more common methods of advertising include billboards and signs, which are posted in locations frequented by many people. These methods of advertising while useful have a significant drawback in that they require large amounts of space. There is therefore a limited amount of signs and billboards which can be placed in an area before the area becomes saturated. Furthermore, signs and billboards often require significant effort to change advertising should one desire replace an old advertisement with a new advertisement.

Other less frequent methods of advertising include wearable signs which are carried by a human operator in a populated area. This method solves some of the problems of space which are involved with normal signs and billboards, though the wearable signs can often be quite uncomfortable for the wearer. Additionally the wearable signs are still static and need to be replaced if a new advertisement is desired.

Recently as technology has progressed, and miniaturisation techniques have been improved, several types of portable electronic devices have been made available. These sort of devices include a range of devices from portable telephones to personal computer which can be mounted on a person's body. Examples of these kinds of devices can be seen in for instance U.S. Pat. No. 6,140,981 to Kuenster et al, and U.S. Pat. No. 6,057,966 to Carroll et al.

There has also been attempts at including video images on garments, see for example U.S. Pat. No. 5,912,653 to Stephan Fitch. This device while allowing changeable images on a person, are not useful for large scale advertising since the display has to be of reduced weight to prevent tearing of the garment.

As can be seen from the prior art there is a need for a portable dynamic display device which can be used for large scale advertising and audiovisual presentations.

Statement of the Invention

### BRIEF DESCRIPTION OF THE DRAWING

FIG. 1 is a side view of one embodiment of a portable dynamic display device according to the present invention.

FIG. 2 is a front view of a support structure according to the embodiment of the invention shown in FIG. 1.

FIG. 3 is a diagram of the interior of a backpack of the embodiment of FIG. 1.

FIG. 4 is diagram of a second embodiment of the present invention.

FIG. 5 is a diagram of the interior of a backpack of the embodiment of FIG. 4.

FIG. 6 is a diagram of the embodiment of the invention shown in FIG. 1.

FIG. 7 is a perspective view of the invention according to the embodiment shown in FIG. 1, shown without a display device.

FIG. 8 is a perspective view of the invention according to the embodiment shown in FIG. 4, shown without a display device.

### DETAILED DESCRIPTION OF THE PREFERRED EMBODIMENTS

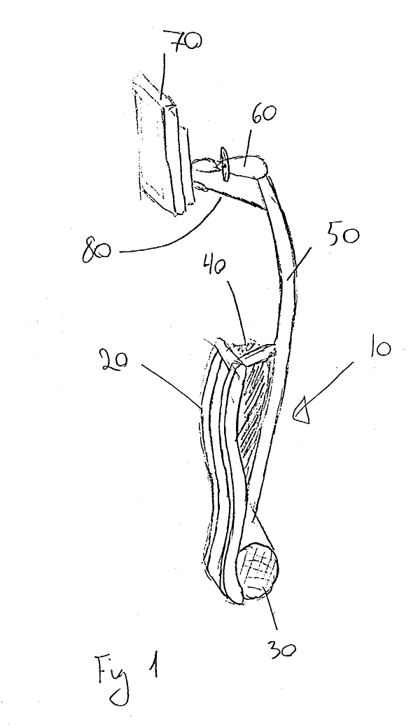

In one aspect, as shown in FIG. 1, the present invention relates to a portable dynamic display device 10. The portable dynamic display device 10 comprises a general support frame 20, on which is mounted a base support means 30, and a carrying sack 40. A hollow tube 50 is attached at one end to the base support means 30. At the other end of hollow tube 50 is mounted a connecting means 60 which is used to attach display device 70 to the hollow tube 50.

The carrying sack 40 contains a media generating means (see below) which is connected to the display device 70 by a cable means 80, which allows for the media generating device to send a generated image to the display device 70 which can then show the image.

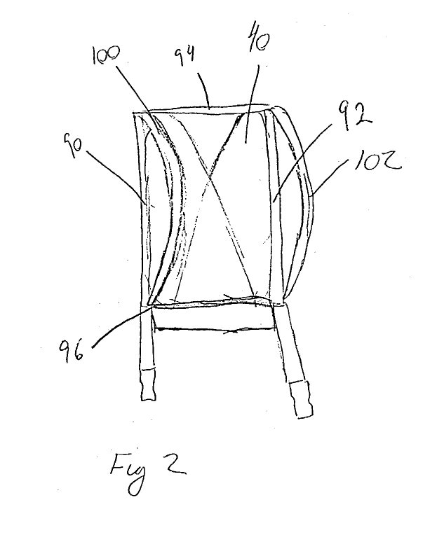

As can be seen in FIG. 2, the general support frame 20, comprises two lateral bars 90 and 92, which are held together by upper and lower bars 94 and 96. The general support frame 20 also has straps 100 and 102 which can be used to fasten the general support frame 20 to the body of a person.

Turning quickly back to FIG. 1. we see that general support frame 20 may have a curvature adapted to fit to the natural curvature of a persons body. This allows for greater comfort while carrying the device.

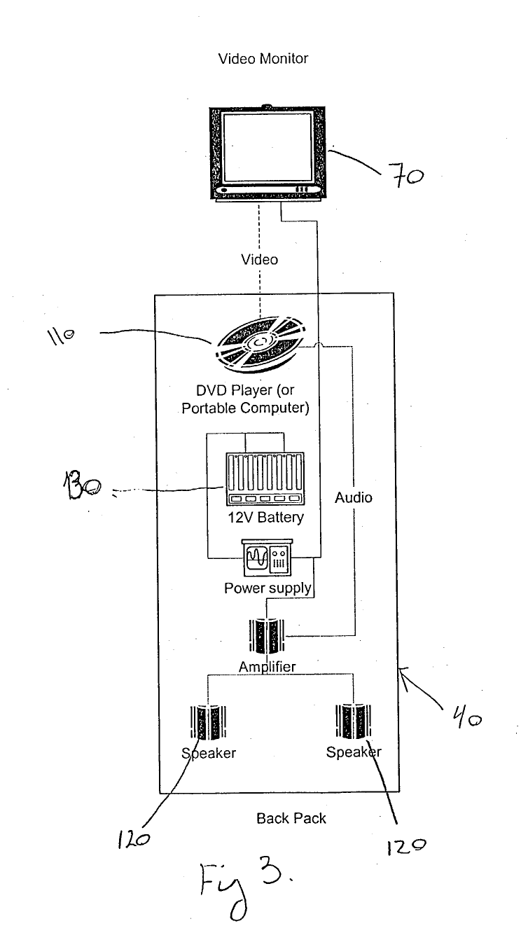

The backpack 40 may be made from a hard plastic shell, and may contain batteries, a media generating means (e.g. a DVD player or a portable computer), and speakers. One example of the contents of the backpack 40 may be seen in FIG. 3. The media generating means 110 generates and image based on a video program which can be stored on a storage means. Said storage means being readable by the media generating means 110.

The media generating means 110 is connected to the display device 70, and the speakers 120 such that the media generating means 110 can play back a video program from a storage means (e.g. a DVD disk or a MPEG-2 file), on the display device 70, and play sounds using the speakers 120. The speakers may also be placed on either end of the base support means 30.

Finally, the backpack 40, also contains a battery 130 or some other power supply which powers the speakers 120 and the display device 70. The media generating device 110 may have its own internal power supply or be powered by the battery 130.

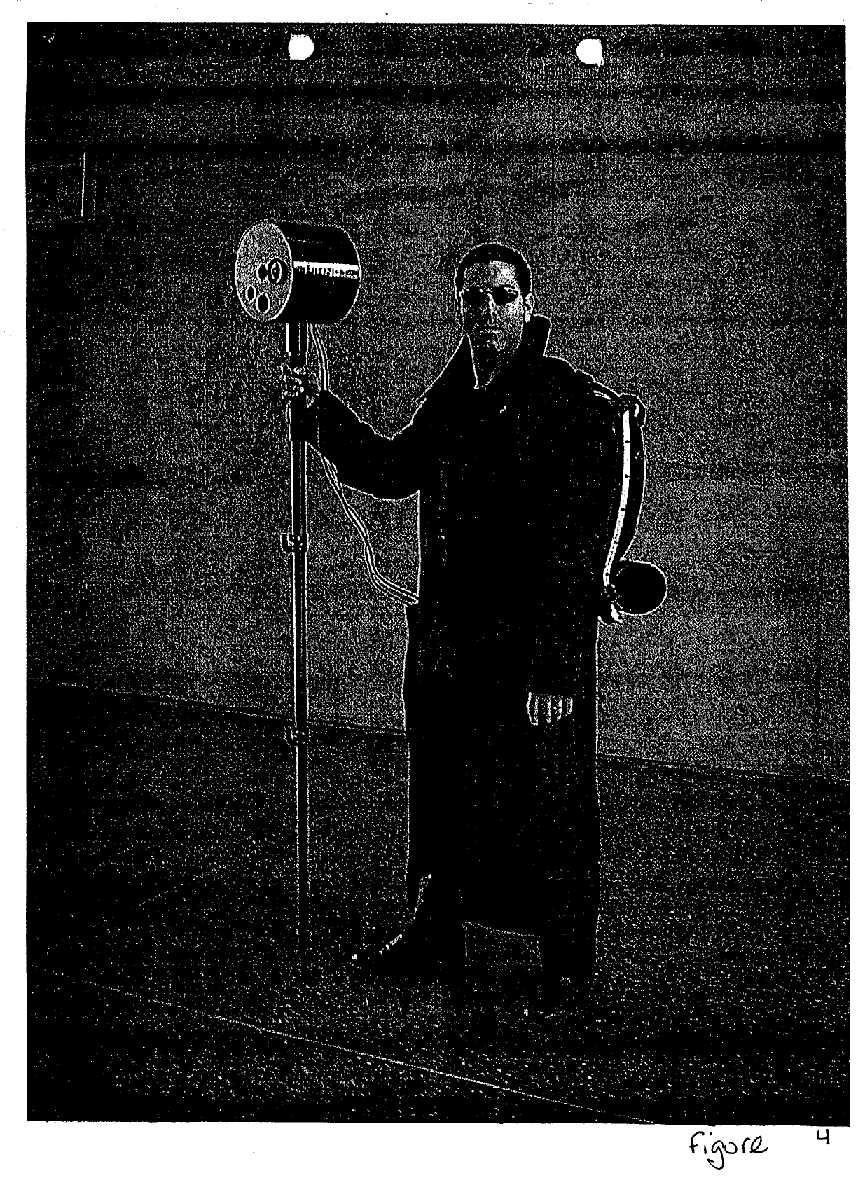

In another embodiment of the invention, see FIG. 4, the display device 70 and the hollow tube 50 may be replaced by a telescoping pole 140 and projector 150. In this embodiment an media generating means stored in the backpack 40, will use the projector 150 to project images for viewing by an audience. The projector 150 may be mounted on a telescoping pole 140 such that an operator 160 can carry the projector 150 or support the projector on the ground via the telescoping pole 140.

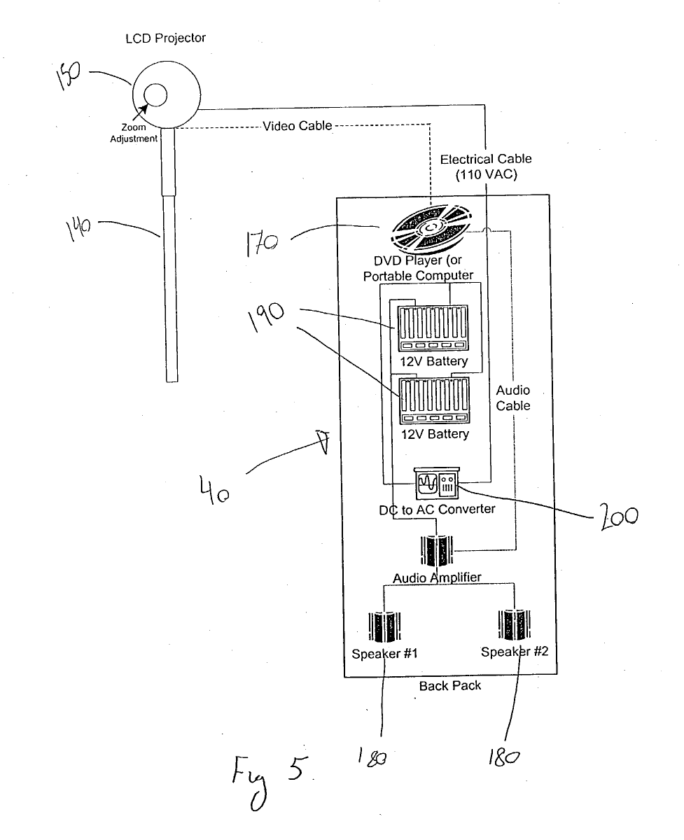

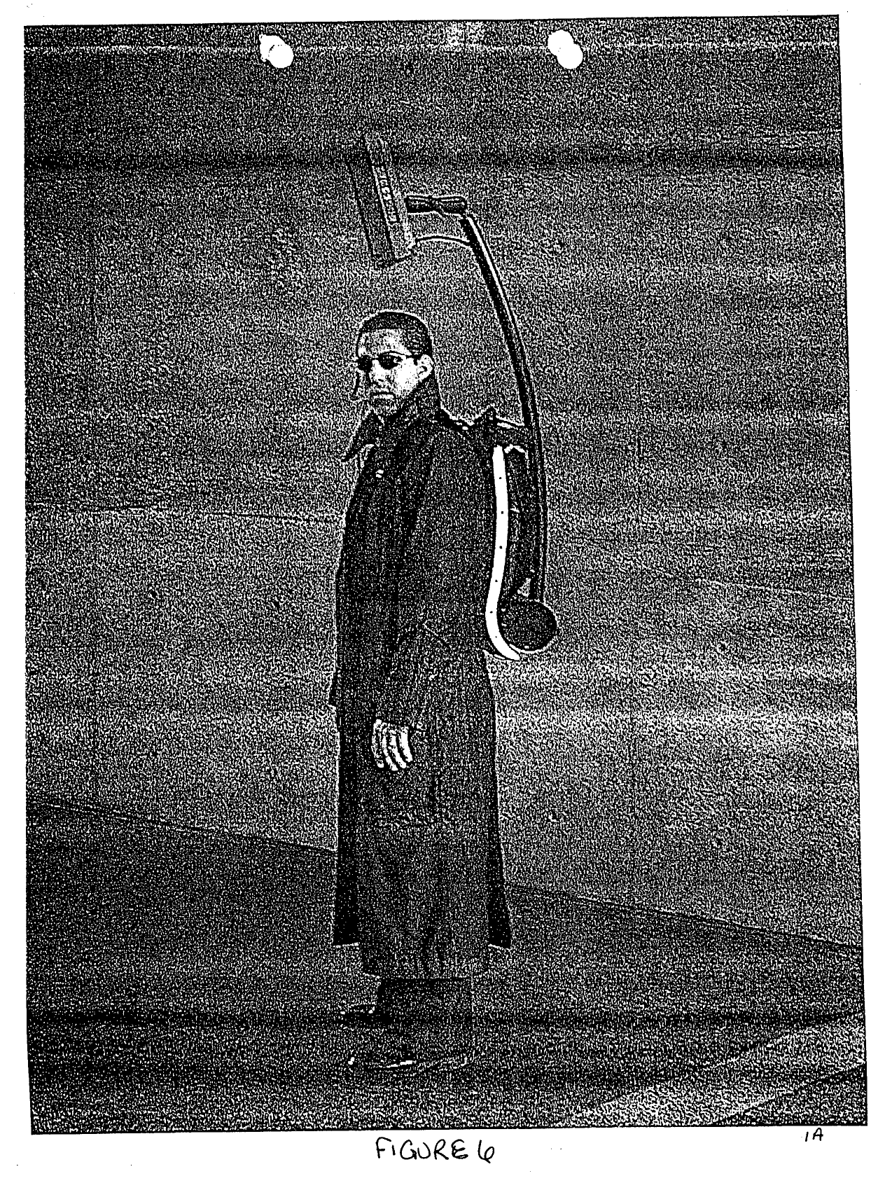

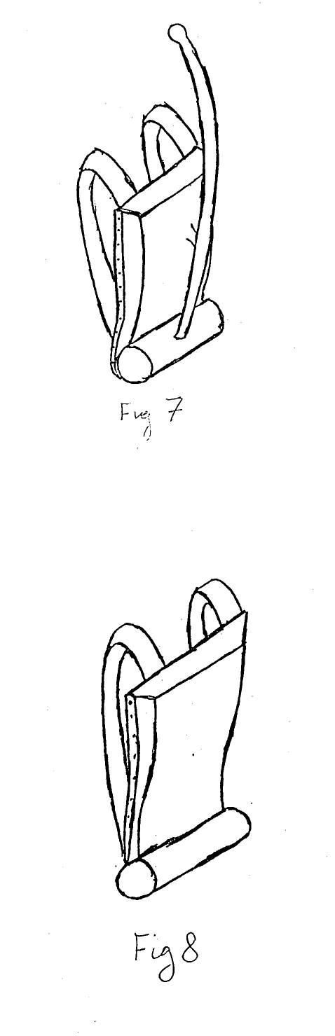

FIG. 5 shows a diagram of the contents of the backpack 40 in the case where a projector 150 is used. In this embodiment the backpack 40, may contain an media generating means 170, such as a DVD player or a portable computer. The media generating means 170 generates an image based on a video program stored on a storage means, for instance a DVD disk or a video file. The media generating means 170 is connected to the projector 150 such that said image generated by the media generating means 170 is projected by the projector 150.

Additionally, the media generating means 170 is connected to a pair of speakers 180 such that an audio component generated by said media generating means 170 can be played back on said speakers.

The backpack 40, also may contain a pair of batteries 190 which power the projector 150 and the speakers 180. The media generating means 150 may have a separate power source or may be connected to the batteries 190. The backpack 40, may also include a DC to AC converted 200 if a AC driven projector is used.

In another aspect the invention includes an out-of-home audiovisual presentation method comprising:

a) the use of a nomadic technology to provide the ability:

a. to present audiovisual content in a moving fashion;

b. to target the time of the presentation;

c. to target the geographical area and the venues in which the content is presented;

b) a human being wearing audiovisual equipment providing the ability:

i) to rapidly change the time or location of the presentation;

ii) to interact with the audience verbally or with signs;

iii) to distribute and hand out collateral materials directly to passerbys;

c) the use of commercially available equipment to enable:

1. reproduction of existing broadcast quality and multimedia content in the MPEG-2 encoding format;

2. playback from any DVD that can be read with a commercial DVD player;

3. playback from any software application that can run on a commercial portable computer;

4. display of any visual content fit for television or computer screens;

5. projection of any visual content for television or computer screens.

In another embodiment the invention may be a wearable and nomadic technology comprising:

a) a costume customizable to each specific activity and facilitating the integration to a specific event or product brand, comprising;

i) a long trench coat designed for hiding the backpack straps;

ii) a hat of round form;

iii) pants to be worn under the trench coat;

iv) semi-transparent mask and gloves;

b) a video monitor perched over the character's head on top of an inverse-T aluminum structure with the following specifications:

i) a direct sunlight 1 viewable LCD display of suitable size;

ii) a marine compliant (NEMA 4X) seal casing for watertight protection;

iii) video inputs compatibility: Standard VGA/SVGA/XGA, Composite Video, S-Video;

iv) resolutions: preferably 800×600 pixels, up to 1280×1024 pixels;

v) on-screen display menu for video adjustments: position, size, brightness, contrast, etc.;

C) a backpack for the monitor set-up made of a hard plastic shell and containing:

i) an inverse-T structure made of aluminum tubes

ii) a low voltage DC audio amplifier (for example 10-watts), and two speakers (for example 10-watts) located on each side of the character's waist in the two extremities of the horizontal tube;

iii) one or more batteries weighing as little as possible, and a low voltage DC regulated power supply;

iv) a commercial type portable DVD player or a portable Windows-compatible computer, both having external audio and video output ports;

d) a video projector standing on a telescopic pole which may be held by the character at different heights and in different positions, with the following specifications:

i) a LCD projector;

ii) very light weight;

iii) native resolution: true XGA 1024×768 or better;

iv) data compatibility: all standard VESA modes, VGA, SVGA, XGA, and SXGA 85 Hz;

v) video compatability: Full NTSC (M 4.43), PAL (BGHI, M, N), SECAM (M), HDTV (720p and 1080i RGBHV);

e) a backpack for the projector set-up made of a hard plastic shell containing:

i) a light weight tube attached at the bottom of the backpack in the horizontal position;

ii) a low voltage VDC audio amplifier, and two speakers located on each side of the character's waist;

iii) one ore more batteries as light as possible, and a DC to AC electrical converter;

iv) a commercial type portable DVD player or a portable Windows-compatible computer, both requiring external audio and video output ports and their own battery pack.

While the invention has been described in relation to several embodiments it will be apparent to those skilled in the art that several modifications and variations not mentioned exists. Accordingly the previous descriptions are only meant for the purposes of illustration, and are not meant to limit the scope of the invention.

1. A portable display device comprising:
a display device capable of displaying an image, said display device disposed on a support member;
an media generating device electronically connected to said display device for generating said image, and transmitting said image to said display device; and
mounting means for attaching said support member to a person.

2. A portable display system comprising:
a video image display for displaying a video image, said video image display being disposed on a support structure mountable on a human body;
a storage device for storing at least one video program including data for generating said video image; and
a video drive connected to said video image display and said storage device for receiving said at least one video program, generating said image, and sending signals to said video image display to display said video image on said video image display.

3. A portable display system as described in claim 2, wherein said support structure comprises:
a frame having straps for strapping said frame on said human body;
a base support member attached to said frame;
an elongated support member attached at one end to said base support member, and at the other end to said video image display.

4. A portable display system as described in claim 2, wherein said support structure is disposed to support said video image display at a height at least the height of said body.

5. A portable display device substantially as described herein.
